(19) United States
(12) Patent Application Publication
(10) Pub. No.: US 2011/0076988 A1
(43) Pub. Date: Mar. 31, 2011

(54) System and Method for Identifying and Cross-Referencing Cellular IDS and Biometrical Characteristics

(76) Inventors: Yafit Zigman, Ramat Hasharon (IL); Tal Shraga Dunksy, Kadima (IL)

(21) Appl. No.: 12/937,749

(22) PCT Filed: Apr. 5, 2009
(86) PCT No.: PCT/IL09/00361

§ 371 Date: Nov. 4, 2010

(30) Foreign Application Priority Data
Apr. 17, 2008 (IL) 190980

(51) Int. Cl. H04W 12/06

(52) U.S. Cl. 455/411

(57) ABSTRACT

System and method for performing access control of entities with identification information to a predetermined passing zone. Accordingly, stimulating signals are transmitted from a transceiver that emulates a unique cellular base station of a legitimate local cellular network to one or more mobile devices that are linked to the entities and are in the vicinity of that zone. The mobile devices that are connected to a conventional cellular network are driven to try registering to the unique base station, by transmitting response signals representing their cellular IDs, to the transceiver, which receives them and forwards them to a control device, connected to the transceiver, for extracting the cellular IDs using an appropriate software application. Then the transceiver may transmit rejecting signals to the mobile devices that tried to register to the unique base station and releases them to return to the conventional cellular network, in a way that is transparent to the cell-phone's user, and/or may send them a cellular message as described above, at the discretion of the operator of the unique base station.

### FIELD OF THE INVENTION

The present, invention relates to the field of Security Monitoring and profiled cellular messaging. More particularly, it relates to a method of and a system for identifying, coupling, storing and cross-referencing cellular IDs and biometrical characteristics to allow access control and monitoring, as well as the creation and maintenance of a database for communication with people, research and cross-referencing of the people and objects being monitored. Profiled cellular messaging is made possible using the captured cellular IDs.

### BACKGROUND OF THE INVENTION

### Definitions

Access control: the ability to monitor and if required, to permit or deny access of an entity that can be identified (a person, a device, a vehicle) to a particular zone.

Subscriber Identity Module (SIM): an electronic card that stores data for cellular telephone subscribers, such as user identity, phone number, network authorization data, personal security keys, contact lists, and stored text messages.

International Mobile Subscriber Identity (IMSI): a unique number associated with all mobile phone users that is stored in the SIM inside the phone and may be sent by the phone to the network on certain occasions (see cell-phone ID).

International Mobile Equipment Identity (IMEI): a unique number associated with a mobile phone, uniquely identifying the hardware (the phone itself, as opposed to the SIM card). May be sent by the phone to the network on certain occasions (see cell phone ID).

Cell-phone ID: the IMSI and/or IMEI and/or equivalent identifiers of a cell-phone read by a base station, or an emulator of a base station, during cellular protocol activities (i.e., origination, termination, registration, location updates).

Cellular messaging: the passing of a message to the cellular device using the cell-phone ID of that device, in the form of a text message (“SMS”), multimedia message (“MMS”), live or recorded voice call, live or recorded video call, downloaded file or application, pushed file or application, and/or data transfer.

Many methods and systems were developed to help to monitor the security access of sensitive places and areas such as airports, governmental institutions, banks and hospitals. We can consider two main approaches: the human-based one, and the physical-based one.

One of the main human-based access control methods is to use the selective access control which is based on a human decision (of security staff) for checking an individual. This decision can be based on a set of criteria like general profiling, abnormal behavior, or attire that does not match the environment or the weather.

A second method is to check all individuals who need or wish to enter a secure perimeter or location, by checking an identity document and asking some security-oriented questions. Some limitations and problems of the human based approaches are, for example, the possible ineffectiveness of human screening for the first one, and the possibility of fake identity documents and bypassing the security questions with lies or pre-trained replies for the second one. Such limitations may lead to infiltrations of unwanted, and possibly dangerous individuals wishing to enter the secure perimeter or location.

A number of physical-based access control methods and systems exist today. The most basic system is a key (mechanical or digital) which allows access of an authorized person. However, an individual may open a door and enter a restricted area, but forget to close the door behind him or voluntarily let other people to come in. This problem is the same with electronic systems like (1) keycards, which pose the same problem, and (2) access control keypads that require a “secret” code which could be communicated to a third party.

Vehicle identification is also often done the same way. A human monitor checks the vehicle, either by eye contact or by remote visual aids such as CCTV. He records the car manually (for example, by writing down its license plate ID). He can match the details of the car with those of the driver. However, in most cases, the human monitor will have no means to track the history of the vehicle, the driver, and their previous links to other persons and devices.

Biometric means of identification, such as fingerprint scanning, handprint scanning, retina scanning, facial recognition, and voice print matching, involve the automated capture, analysis, and comparison of specific characteristics of these human body attributes. In order to be efficient, these access control technologies need to acquire the initial data more than once to have accurate measurements, and the procedure requires that the individual being checked be made aware of it. Additionally, the individual being checked needs to be in a relatively still state to allow the system to operate properly.

The Radio-Frequency identification (RFID) is an automatic identification method and system. It is based on storing and remotely retrieving data using devices called RFID tags or transponders. These can be applied to or incorporated with an object (product or individual) for the purpose of identification using radio waves. Some RFID transponders can be read from several meters of the receiver. This technology allows efficient access control without human intervention, but it needs to know the product or the individual who has received the RFID tag before registration to allow him access to an area or to trace his whereabouts.

For the more particular case of access monitoring (which can be defined as a sub-field of access control), cameras, activity sensors and the RFID tag technologies can be used. However, all the methods and the systems above have not provided a satisfactory solution to the problem of access control and monitoring a group that includes unknown random persons or objects, like persons or vehicles in an airport, a shopping mall, a hospital, etc. They also don't enable cross-referencing between persons, objects, and the connections between them, for research and for fine-tuning future access control.

It is an object of the present invention to provide a system and a method for identifying a cell-phone or other Radio Frequency (“RF”) based communication device (will be named “cell-phone” thereafter) and/or modules in it (such as a SIM card in a GSM cellular device) in a specific and narrow area the person carrying/using the cell-phone is passing through.

It is another object of the present invention, to provide a subsystem for collecting identification data from mobile devices and/or modules, a subsystem for identifying the persons carrying them through biometric identifiers, a subsystem that would identify the characteristics of vehicles such as license plate IDs, and a database that would store the data and allow cross-referencing between the different types of data in various ways.

It is a further object of the present invention to correlate between the above data items as they are being read into the system, in order to update the database used for cross-referencing and allow efficient access control and event-driven activities based on each single data item or combination of several items and/or events.

It is still an object of the present invention that, it can be installed in several sensitive places to allow sharing of information. The more systems will be deployed, the more widely and efficiently the database can be used and shared. Furthermore, this will allow a more reliable and accurate database and a variety of reports can be created.

It is yet another object of the present invention, to initiate communication with users based on the identification of their cell-phones, for forwarding them individual content and messages of interest.

Further purposes and advantages of this invention will appear as the description proceeds.

### SUMMARY OF THE INVENTION

The present invention is directed to a method for performing access control of entities (e.g., a person, suspected persons or groups, a device or a vehicle) with identification information (e.g., a biometrical characteristic, license plate data of a vehicle) to a predetermined passing zone (e.g., a gate, an essential narrow passing zone, a vehicle approach or stop area, a room, a perimeter inside another room, a basket in which cellular devices are placed or a border-crossing point). Accordingly, stimulating signals are transmitted from a transceiver that emulates a unique cellular base station of a legitimate local cellular network to one or more mobile devices (such as cellular phones, laptops with cellular connectivity, PDAs with cellular connectivity or Pocket PCs with cellular connectivity) that are linked to the said entities and are in the vicinity of that zone. The mobile devices that are connected to a conventional cellular network are driven to try registering to the unique base station, by transmitting response signals representing their cellular IDs (e.g., an IMSI, an IMEI or any data used for billing an owner of a SIM card), to the transceiver, which receives them and forwards them to a control device, connected to the transceiver, for extracting the cellular IDs using an appropriate software application. Then the transceiver may transmit rejecting signals to the mobile devices that tried to register to the unique base station and releases them to return to the conventional cellular network, in a way that is transparent to the cell-phone's user, and/or may send them a cellular message as described above, at the discretion of the operator of the unique base station.

Association between the cellular IDs and other forms of identification information is made and the cellular IDs and the associating results are stored in data storage, such as a local or remote database.

Cross-referencing may be made with data obtained from interfaces to biometric devices, other databases that include other IDs, or vehicle identification devices.

Information about an entity stored in an external database may be updated according to the association results.

The transceiver transmits via an antenna which is selected per location according to its physical size and appearance, directionality, signal range and strength, and/or the RF isolation from the surrounding environment. The antenna may also be an array or any combination of antennas that are connected to the transceiver.

On-line alert may be provided about the presence of suspicious persons or devices in the predetermined passing zone.

Each record in the database has its time stamp of creation and last update, for allowing multiple cross-references between different mobile devices, persons and events.

Linking between persons may be provided via the phones and/or SIM cards and/or vehicles they use; tracking SIM cards that had been passed from phone to phone; show the history of phones and SIM cards, their interconnections, and the people who carried them; linking between several phones used by the same person or group of persons; linking between persons who use the same phone, SIM card, or both; tracing rented or pre-paid phones, and linking them to a person or a group of persons; linking the cell phones and persons using them with the vehicles they use; linking between persons using the same vehicles.

The extracted cellular ID may be used for initiating communication with the cell-phone's user for sending cellular massages of interest to the operator of the unique base station.

The massages of interest may include directions, further instructions, message of interest that can be adapted to the profile of interests of the user, segmented, individually customized cellular messages.

The individually customized cellular messages may be profiled according to the cellular device's ID information, including the device manufacturer, device type, device model, home country, home network, and the history of the device, the person(s) and/or vehicle(s) linked to it.

The content of the initiated communication may include sending cellular massages to the cellular device of the user regarding directions, further instructions, or any other message of interest that can be adapted to his profile or interests, commercial offers of providers that may be located in the vicinity of the device, via cellular messaging or any other way to aurally or visually communicate with the user.

The cellular ID of the device may be used for sending segmented, individually customized cellular messages, using information based on the cellular ID and the history of the device, the person(s) and/or vehicle(s) linked to it, as recorded in the system database or in other external databases that are linked to the system.

The present invention is also directed to a system for performing access control of entities having identification information to a predetermined passing zone, that comprises:
a) A transceiver for transmitting stimulating signals emulating a unique cellular base station of a legitimate local cellular network to one or more mobile devices that are connected to the entities and being in the vicinity of the zone, the stimulating signals causing the mobile devices that are connected to a conventional cellular network to try registering to the unique base station, by transmitting response signals representing their cellular IDs, to the transceiver;
b) An antenna for receiving the response signals into the transceiver;
c) a control device connected to the transceiver, for:
c.1) extracting the cellular IDs by using an appropriate software application;
c.2) causing the mobile devices that tried to register to the unique base station to remain connected to their conventional cellular network, by generating ejecting signals transmitted by the transceiver and releasing them to return to the conventional cellular network, in a way that is transparent to the cell-phone's user; and
d) a data storage for associating between the cellular IDs and the identification information and storing the cellular IDs and the associating results.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 schematically illustrates a system for identifying, coupling, storing and cross-referencing cellular IDs and biometrical characteristics, according to the invention.

### DETAILED DESCRIPTION OF PREFERRED EMBODIMENTS

According to some embodiments of the present invention, the system is composed mainly by a control device with an appropriate software application, a transceiver acting as a base station with unique parameters adapted to read an identification string from an RF device such as a cell-phone within a confined area, an antenna, a local or remote database for storing and retrieving information, and optional interfaces to biometric devices and other databases that include IDs, such as vehicle identification devices. It can be installed and used discreetly, allowing access monitoring or data collection unbeknownst to the individuals being checked and without alerting them.

The proposed system is also able to provide new and updated information such as a suspect's hidden cell-phone ID and retrieve biometric characteristics, and/or the characteristics of the vehicle he has used during the identification process, in order to associate between these characteristics and the cell-phone ID. The cell-phone ID can be used later for intelligence needs such as tracking. In some other cases the information on a suspect can be retrieved after an event had occurred by searching in the database information.

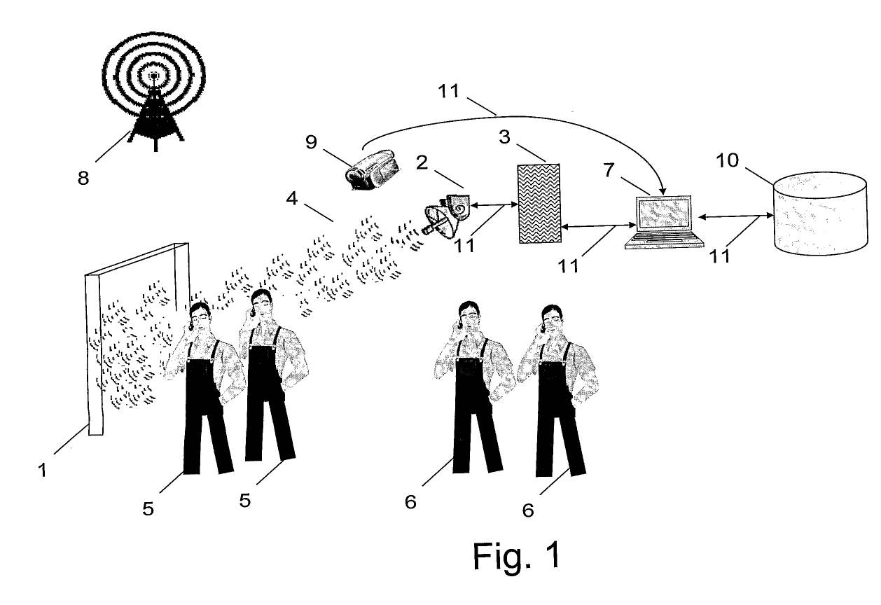

For example, the access monitoring process can be described as follows and in accordance with FIG. 1. The access point to a place, defined by a door or a vehicle entrance (1), needs to be monitored. In order to do so, a directional antenna (2) is placed nearby at a distance which allows efficient monitoring of the gate (or any other essential narrow passing zone) and its vicinity. The narrow zone can be a vehicle approach or stop area, a room, a perimeter inside another room, or even a small basket in which cellular devices are placed (i.e. before going through a metal detector in an airport or border-crossing).

More particularly, the system transmits a signal through the antenna (4) which is emitted toward the gate direction, and signals being transmitted from the direction of the gate are received by the system. This configuration allows capturing information only from cell phones (5) which are in the antenna's radiation pattern area. The antenna (2) will be selected based on the needs of the location in terms of physical size and appearance, directionality, signal range and strength, and RF isolation from the surrounding environment. It may be accompanied by other aids for extra RF isolation such as physical barriers made of conductive materials. This antenna is connected to the base station (3) which emulates a legitimate cellular radio base station with unique parameters, forcing the cell-phone to register on it and transmit its identification details (such as IMSI and IMEI) in order to store the data in the system. The collected data is sent to a control device (7). Following that, the transceiver may send a signal (4) to the cell phone, rejecting the cell-phone's registration and releasing it back to its cellular operator's network, which may be preceded by sending a message to the device using cellular massaging, as it is defined above, regarding directions, further instructions, or any other message. (8) The time needed to capture the cell phone data is short and has minimal impact on the cellular operator's network services of the checked individuals. At the same time, biometric characteristics of the individuals and/or vehicle characteristics (such as the license plate ID) (5) are acquired with biometric devices such as a face recognition system (6) and/or license plate recognition devices, and transmitted to the control device (7). All the individuals' cell phone ID, biometric characteristics, and/or vehicle characteristics are linked and stored in a database (10). All these data can be used to detect suspected persons or groups, or for profiling the device and its user or users.

Once the data is collected into the database, the system can provide on-line alert regarding the presence of a person or a device who are suspicious, or of other interest; allow linking between persons via the phones or SIM cards and/or vehicles they use; track SIM cards that had been passed from phone to phone; show the history of phones and SIM cards, the links between them, and the persons who used them; etc.

The system can also cross this data with other worldwide systems.

Should a comparison of the acquired cell-phone ID, biometrical identification, and/or vehicle identification, produce a match with a relevant database entry, then some or all of the acquired information and the relevant, updated database record may be forwarded to the operator of the unique base station (e.g. law enforcement, etc.) for them to take action or update their own data.

According to some embodiments of the present invention, cross-referencing cell phones and biometrics data, and storing them can yield important information on several levels:
Linking between several phones being used by the same person or group of persons.
Linking persons who use the same phone, SIM card, or both; these persons may be concluded to belong to the same group or organization.
Tracing rented or pre-paid phones, and linking them to a person or a group of persons; thus being able to trace back to where and when the phone was rented or purchased, placing that person or group at that place at that time.
Linking the cell phones and persons using them with the vehicles they use.
Linking between persons using the same vehicles.

The system enables the creation and updating of a database that includes information about mobile devices, persons, vehicles, and the links between them. Each record in the database has its time stamp of creation and last update, for allowing multiple cross-references between different mobile devices, persons and events (which can be defined by updates' timing), possibly having ties between them or belonging to the same group or organization.

According to another embodiment of the invention, the extracted cellular ID may be used for initiating communication with the cell-phone's user, in order to send cellular massages to his cellular device regarding directions, further instructions, or any other message of interest that can be adapted to his profile or interests. For example, the cellular ID of the device can be used to send segmented, individually customized cellular messages, using information based on the cellular ID (such as the device manufacturer, device type, device model, home country, home network) and the history of the device, the person(s) and/or vehicle(s) linked to it, as recorded in the system database or in other external databases that are linked to the system. The content of such initiated communication may also include commercial offers of providers that may be located in the vicinity of the device, via cellular messaging or any other way to aurally or visually communicate with the user.

If the user will be interested in a particular type of product, he may receive personalized messages regarding information about sales, special offers or any kind of information that can be useful (e.g., tourist information etc.).

Although embodiments of the invention have been described by way of illustration, it will be understood that the invention may be carried out with many variations, modifications, and adaptations, without exceeding the scope of the claims.

1. A method for performing access control of entities having identification information to a predetermined passing zone, comprising:
a) transmitting stimulating signals from a transceiver emulating a unique cellular base station of a legitimate local cellular network to one or more mobile devices that are connected to said entities and being in the vicinity of said zone;
b) causing the mobile devices that are connected to a conventional cellular network to try registering to said unique base station, by transmitting response signals representing their cellular IDs, to said transceiver;
c) receiving said response signals in said transceiver and extracting said cellular IDs by a control device connected to said transceiver, using an appropriate software application;
d) causing the mobile devices that tried to register to said unique base station to remain connected to their conventional cellular network, by transmitting them rejecting signals by said transceiver and releasing them to return to said conventional cellular network, in a way that is transparent to the cell-phone's user;
e) associating between said cellular IDs and said identification information and storing said cellular IDs and the associating results in a data storage;
wherein said unique base station is not registered in said legitimate cellular network.

2. (canceled)

3. (canceled)

4. (canceled)

5. (canceled)

6. (canceled)

7. (canceled)

8. A method according to claim 1, wherein cross-referencing is made with data obtained from interfaces to:
a) biometric devices; other databases that include IDs;
b) vehicle identification devices.

9. A method according to claim 1, further comprising updating information about an entity stored in an external database, according to the association results.

10. A method according to claim 1, further comprising updating information about an entity stored in an external database, according to the association results.

11. (canceled)

12. (canceled)

13. (canceled)

14. A method according to claim 1, wherein each record in the database has its time stamp of creation and last update, for allowing multiple cross-references between different mobile devices, persons and events.

15. A method according to claim 1, further comprising:
a) providing linking between persons via the phones or SIM cards and/or vehicles they use;
b) tracking SIM cards that had been passed from phone to phone;
c) show the history of phones and SIM cards, their interconnections, and the people who carried them.
d) linking between several phones being used by the same person or group of persons.
e) linking between persons who use the same phone, SIM card, or both;
f) Tracing rented or pre-paid phones, and linking them to a person or a group of persons;
g) Linking the cell phones and persons using them with the vehicles they use;
h) Linking between persons using the same vehicles.

16. A method according to claim 1, further comprising using the extracted cellular ID for initiating communication with the cell-phone's user for sending cellular messages of interest to the operator of the unique base station.

17. A method according to claim 16, wherein the messages of interest include directions, further instructions, message of interest that can be adapted to the profile of interests of said user, segmented, individually customized cellular messages.

18. (canceled)

19. A method according to claim 16, wherein the content of the initiated communication includes sending cellular messages to the cellular device of the user regarding directions, further instructions, or any other message of interest that can be adapted to his profile or interests, commercial offers of providers that may be located in the vicinity of the device, via cellular messaging or any other way to aurally or visually communicate with said user.

20. A method according to claim 16, wherein the cellular ID of the device is used for sending segmented, individually customized cellular messages, using information based on said cellular ID and the history of the device, the person(s) and/or vehicle(s) linked to it, as recorded in the system database or in other external databases that are linked to the system.

21. A system for performing access control of entities having identification information to a predetermined passing zone, comprising:
a) A transceiver for transmitting stimulating signals emulating a unique cellular base station of a legitimate local cellular network to one or more mobile devices that are connected to said entities and being in the vicinity of said zone, said stimulating signals causing the mobile devices that are connected to a conventional cellular network to try registering to said unique base station, by transmitting response signals representing their cellular IDs, to said transceiver;
b) An antenna for receiving said response signals into said transceiver;
c) a control device connected to said transceiver, for:
c.1) extracting said cellular IDs by using an appropriate software application;
c.2) causing the mobile devices that tried to register to said unique base station to remain connected to their conventional cellular network, by generating ejecting signals transmitted by said transceiver and releasing them to return to said conventional cellular network, in a way that is transparent to the cell-phone's user; and
d) a data storage for associating between said cellular IDs and said identification information and storing said cellular IDs and the associating results;
wherein said unique base station is not registered in said legitimate cellular network.

22. (canceled)

23. (canceled)

24. (canceled)

25. A system according to claim 21, in which the identification information includes:
a) a biometrical characteristic;
b) license plate data of a vehicle.

26. (canceled)

27. (canceled)

28. (canceled)

29. A system according to claim 21, further comprising updating information about an entity stored in an external database, according to the association results.

30. A system according to claim 21, in which information about an entity stored in an external database is updated according to the association results.

31. A system according to claim 21, in which the transceiver transmits via an antenna according to:
a) its physical size and appearance
b) its directionality;
c) its signal range and strength;
d) its RF isolation from the surrounding environment.

32. (canceled)

33. (canceled)

34. A system according to claim 21, in which each record in the database has its time stamp of creation and last update, for allowing multiple cross-references between different mobile devices, persons and events.

35. A system according to claim 21, in which the extracted cellular ID is used for initiating communication with the cell-phone's user for sending cellular messages of interest to the operator of the unique base station.

36. A system according to claim 35, in which the messages of interest include directions, further instructions, message of interest that can be adapted to the profile of interests of said user, segmented, individually customized cellular messages.

37. A system according to claim 36, in which the individually customized cellular messages are profiled according to the cellular device's ID information, including the device manufacturer, device type, device model, home country, home network, and the history of the device, the person(s) and/or vehicle(s) linked to it.

38. A system according to claim 35, in which the content of the initiated communication includes sending cellular messages to the cellular device of the user regarding directions, further instructions, or any other message of interest that can be adapted to his profile or interests, commercial offers of providers that may be located in the vicinity of the device, via cellular messaging or any other way to aurally or visually communicate with said user.

39. (canceled)
